(19) United States
(12) Patent Application Publication
(10) Pub. No.: US 2026/0189379 A1
(43) Pub. Date: Jul. 2, 2026

(54) COMPACT FUNCTIONAL ENCRYPTION FOR UNBOUNDED ATTRIBUTE-WEIGHTED SUMS

(71) Applicant: NTT Research, Inc., Sunnyvale, CA (US)

(72) Inventors: Pratish DATTA, Sunnyvale, CA (US); Tapas PAL, Sunnyvale, CA (US)

(73) Assignee: NTT Research, Inc., Sunnyvale, CA (US)

(21) Appl. No.: 19/127,364

(22) PCT Filed: Nov. 6, 2023
(86) PCT No.: PCT/US2023/078860

§ 371 Date: May 5, 2025

Related U.S. Application Data
(60) Provisional application No. 63/382,525, filed on Nov. 6, 2022.

(51) Int. Cl. H04L 9/08; H04L 9/06; H04L 9/30

(52) U.S. Cl. CPC H04L 9/0861; H04L 9/0618; H04L 9/0894; H04L 9/3073

(57) ABSTRACT

Techniques are disclosed relating to functional encryption schemes for attribute-weighted sum (AWS) functionality that support the uniform model of computation. In some embodiments, a device is configured for encrypting for a functional encryption scheme in the public key setting supporting multiple secret keys and multiple ciphertexts. In some embodiments the disclosed techniques may support both public and private attributes of arbitrary lengths.

### CROSS-REFERENCE TO RELATED APPLICATION

This application claims the benefit of U.S. Provisional Application Ser. No. 63/382,525 filed Nov. 6, 2022, the content of which is incorporated by reference herein in its entirety.

### FIELD OF THE INVENTION

The invention relates to functional encryption schemes for attribute-weighted sum (AWS) functionality that support the uniform model of computation.

### BACKGROUND OF THE INVENTION

Functional Encryption Functional encryption (FE), formally introduced by Boneh et al. and O'Neill, redefines the classical encryption procedure with the motivation to overcome the limitation of the “all-or-nothing” paradigm of decryption. In a traditional encryption system, there is a single secret key such that a user given a ciphertext can either recover the whole message or learns nothing about it, depending on the availability of the secret key. FE in contrast provides fine grained access control over encrypted data by generating artistic secret keys according to the desired functions of the encrypted data to be disclosed. More specifically, in a public-key FE scheme for a function class [symbol] , there is a setup authority which produces a master secret key and publishes a master public key. Using the master secret key, the setup authority can derive secret keys or functional decryption keys SK_{ƒ} associated with functions ƒ∈ [symbol] . Anyone can encrypt messages msg belonging to a specified message space msg∈ [symbol] using the master public key to produce a ciphertext CT. The ciphertext CT along with a secret key SK_{ƒ} recovers the function of the message ƒ(msg) at the time of decryption, while unable to extract any other information about msg. More specifically, the security of FE requires collusion resistance meaning that any polynomial number of secret keys together cannot gather more information about an encrypted message except the union of what each of the secret keys can learn individually.

FE for Attribute-Weighted Sum We are aware of FE schemes for a new class of functionalities termed as “attribute-weighted sums” (AWS). This is a generalization of the inner product functional encryption (IPFE). In such a scheme, an attribute pair (x, z) is encrypted using the master public key of the scheme, where x is a public attribute (e.g., demographic data) and z is a private attribute containing sensitive information (e.g., salary, medical condition, loans, college admission outcomes). A recipient having a secret key corresponding to a weight function ƒ can learn the attribute-weighted sum ƒ(x)z. The attribute-weighted sum functionality appears naturally in several real life applications. For instance, as discussed by Abdalla et al. if we consider the weight function ƒ as a boolean predicate, then the attribute-weighted sum functionality ƒ(x) would correspond to the average z over all users whose attribute x satisfies the predicate ƒ. Important practical scenarios include average salaries of minority groups holding a particular job (z=salary) and approval ratings of an election candidate amongst specific demographic groups in a particular state (z=rating).

Other works considered a more general case of the notion where the domain and range of the weight functions are vectors, in particular, the attribute pair of public/private attribute vectors (x, z), which is encrypted to a ciphertext CT. A secret key SK_{ƒ} generated for a weight function ƒ allows a recipient to learn ƒ(x)^{T}z from CT without leaking any information about the private attribute z.

Other FE schemes support an expressive function class of arithmetic branching programs (ABPs) which captures non-uniform Logspace computations. Other schemes were built in asymmetric bilinear groups of prime order and are proven secure in the simulation-based security model, which is known to be the desirable security model for FE, under the (bilateral) k-Linear (k-Lin)/(bilateral) Matrix Diffie-Hellman (MDDH) assumption. Another FE scheme achieves semi-adaptive security, where the adversary is restricted to making secret key queries only after making the ciphertext queries, whereas another FE scheme achieves adaptive security, where the adversary is allowed to make secret key queries both before and after the ciphertext queries.

However, as mentioned above, ABP is a non-uniform computational model. As such, in both the FE schemes, the length of the public and private attribute vectors must be fixed at system setup. This is clearly a bottleneck in several applications of this primitive especially when the computation is done over attributes whose lengths vary widely among ciphertexts and are not fixed at system setup. For instance, suppose a government hires an external audit service to perform a survey on average salary of employees working under different job categories in various companies to resolve salary discrepancy. The companies create salary databases (X, Z) where X=(xᵢ)ᵢ contains public attributes xᵢ=(job title, department, company name) and Z=(zᵢ)ᵢ includes private attribute zᵢ=salary. To facilitate this auditing process without revealing individual salaries (private attribute) to the auditor, the companies encrypt their own database (X, Z) using an FE scheme for AWS. The government provides the auditor a functional secret key SK_{ƒ} for a function ƒ that takes input a public attribute X and outputs 1 for xᵢ's for which the “job title” matches with a particular job, say manager. The auditor decrypts ciphertexts of the various companies using SKs and calculates the average salaries of employees working under that job category in those companies. Now, if the existing FE schemes for AWS supporting non-uniform computations are employed then to make the system sustainable the government would have to fix a probable size (an upper bound) of the number of employees in all the companies. Also, the size of all ciphertexts ever generated would scale with that upper bound even if the number of employees in some companies, at the time of encryption, are much smaller than that upper bound.

Thus, there is a need for an FE scheme for AWS in some uniform computational model capable of handling public/private attributes of arbitrary length.

### BRIEF SUMMARY OF THE INVENTION

Disclosed herein is the first functional encryption (FE) scheme for the attribute-weighted sum (AWS) functionality that supports the uniform model of computation. In embodiments of such an FE scheme, encryption takes as input a pair of attributes (x, z) where the attribute x is public while the attribute z is private. A secret key corresponds to some weight function ƒ, and decryption recovers the weighted sum ƒ(x)z. This functionality has a wide range of potential real life applications, many of which require the attribute lengths to be flexible rather than being fixed at system setup. In the disclosed scheme, the public attributes can be considered as binary strings while the private attributes are considered as vectors over some finite field, both having arbitrary polynomial lengths that are not fixed at system setup. The weight functions are modelled as Logspace Turing machines. The disclosed scheme is built in asymmetric prime-order bilinear groups and is proven adaptively simulation secure under the well-studied symmetric external Diffie-Hellman (SXDH) assumption against an arbitrary polynomial number of secret key queries both before and after the challenge ciphertext. This is the best possible level of security for FE as noted in the literature. As a special case of the disclosed FE scheme, also disclosed is the first adaptively simulation secure inner-product FE (IPFE) for vectors of arbitrary length that is not fixed at system setup.

Some embodiments of the invention include systems, methods, network devices, and machine-readable media for encrypting for a functional encryption scheme in a public key setting supporting multiple secret keys and multiple ciphertexts, the method including: executing a computerized setup algorithm, the setup algorithm comprising: receiving a security parameter; executing a functional encryption setup algorithm twice to generate a set of master public-secret key pairs FE.MSK and FE.MPK and a set of master public-secret key pairs [symbol] and [symbol] ; outputting a master secret key MSK as FE.MSK and [symbol] and a master public key MPK as FE.MPK and [symbol] , and storing the output master keys in an electronic setup storage unit, wherein the master keys MSK and MPK only depend on the security parameter; executing a computerized key generation algorithm by: receiving the master secret key MSK as FE.MSK and [symbol] from the setup storage unit and a function M= [symbol] where Mₜ are sub-functions, wherein t represents an integer index and Mₜ accepts an arbitrary length of inputs and Mₜ is computed by multiplying several matrices M_{t,τ}, wherein τ represents an integer index and wherein [symbol] represents a set of indices being natural numbers; sampling random values α, βₜ such that a sum of all entries of βₜ is 0; setting value v_{pad} comprising α and padded with zeroes and generating an FE secret key FE.SK_{pad} for the values v_{pad}; sampling random values rₜ for setting values v_{t,init} comprising rₜ and βₜ, padded with zeroes and appended with a randomized encoding of the index t and generating an FE secret key FE.SK_{t,init} for the values v_{t,init}; setting values vₜ comprising rₜ, M_{t,τ}, padded with zeroes and appended with a randomized encoding of the index t and generating an FE secret key FE.SKₜ for the values vₜ; setting values \tilde{v}ₜ comprising rₜ, α, padded with zeroes and appended with a randomized encoding of the index t and generating an FE secret key [symbol] for the values \tilde{v}ₜ; and outputting the secret key SK_{M} as FE.SK_{pad}, {FE.SK_{t,init}, FE.SKₜ}, { [symbol] } and M, and storing the output in an electronic key generation storage unit.

Some embodiments further include an encryption method, the encryption method including: receiving the master public key MPK as FE.MPK and [symbol] , one or more public attributes x, and one or more private attributes z= [symbol] wherein t represents an integer index; sampling randomness s and setting values u_{pad} comprising s, padding with zeroes, and computing FE ciphertext FE.CT_{pad} for the value u_{pad}; sampling random values rₓ for setting values u_{t,init} comprising rₓ, s, padded with zeroes and appended with a randomized encoding of the index t, and computing FE ciphertext FE.CT_{t,init} for the value u_{t,init}; computing coefficients cₜ comprising x, rₓ and setting values uₜ comprising rₓ, S, cₜ, padded with zeroes and appended with a randomized encoding of the index t, and computing FE ciphertext FE.CTₜ for the value uₜ; setting values ũₜ comprising rₓ, s, zₜ, padded with zeroes and appended with a randomized encoding of the index t, and computing FE ciphertext [symbol] for the value ũₜ; and outputting the ciphertext CT as FE.CT_{pad} and {FE.CT_{t,init}, FE.CTₜ}, { [symbol] } and storing the output in an electronic encryption device storage unit.

Some embodiments further include decryption method, the decryption method including: receiving the function M and the secret key SK_{M} for function M; receiving one or more public attributes x and a ciphertext CT for x; retrieving FE.SK_{pad}, {FE.SK_{t,init}, FE.SKₜ}, { [symbol] } from SK_{M} and retrieving FE.CT_{pad} and {FE.CT_{t,init}, FE.CTₜ}, { [symbol] } from CT; retrieving sub-functions Mₜ from the function M; upon verifying [symbol] ⊆ [symbol] proceeds as follows: decrypting FE.CT_{pad} by running the decryption algorithm of FE using the secret key FE.SK_{pad} and get a value ρ_{pad}; decrypting FE.CT_{t,init} by running the decryption algorithm of FE using the secret key FE.SK_{t,init} and get a value [symbol] ᵢₙᵢₜ; decrypting FE.CTₜ by running the decryption algorithm of FE using the secret key FE.SKₜ and get a value [symbol] ; decrypting [symbol] by running the decryption algorithm of FE using the secret key [symbol] and get a value [symbol] ; running an evaluation algorithm of a garbling procedure using the values [symbol] ᵢₙᵢₜ, [symbol] , [symbol] and the one or more public attributes x and the sub-function Mₜ, and get a value d; and recovering the functional value μ from ρ_{pad} and d, and outputting the value μ as the plaintext and storing the output in an electronic decryption device storage unit.

In some further embodiments, a first FE key pair (FE.MPK, FE.MSK) is for encrypting a public part of attributes and the second FE key pair ( [symbol] , FE.MSK) is for use in encrypting a private part of the attributes.

Some embodiments of the invention include systems, methods, network devices, and machine-readable media for encrypting for a functional encryption scheme in a private key setting supporting at least one secret key and one ciphertext, the method comprising: executing a computerized setup algorithm, the setup algorithm comprising: receiving a security parameter; executing a functional encryption setup algorithm twice to generate master secret key pairs FE.MSK and [symbol] ; outputting a master secret key MSK as FE.MSK and [symbol] , and storing the output master keys in an electronic setup storage unit, wherein the master key MSK only depends on the security parameter; executing a computerized key generation algorithm by: receiving the master secret key MSK as FE.MSK and [symbol] from the setup storage unit and a function M= [symbol] where Mₜ are sub-functions, wherein t represents an integer index and Mₜ accepts arbitrary length of inputs and Mₜ is computed by multiplying several matrices M_{t,τ}, wherein τ represents an integer index and wherein [symbol] represents a set of indices being natural numbers; sampling random values βₜ such that the sum of all entries of βₜ is 0; sampling random values rₜ for setting values v_{t,init} comprising rₜ and βₜ, padded with zeroes and appended with a randomized encoding of the index t and generating an FE secret key FE.SK_{t,init} for the values v_{t,init}; setting values vₜ comprising rₜ, M_{t,τ}, padded with zeroes and appended with a randomized encoding of the index t and generating an FE secret key FE.SKₜ for the values vₜ; setting values \tilde{v}ₜ comprising rₜ, padded with zeroes and appended with a randomized encoding of the index t and generating an FE secret key [symbol] for the values \tilde{v}ₜ; and outputting the secret key SK_{M} as {FE.SK_{t,init}, FE.SKₜ}, { [symbol] } and M, and storing the output in an electronic key generation storage unit.

Some embodiments further include an encryption method, the encryption method including: receiving the master secret key MSK as FE.MSK and [symbol] , one or more public attributes x, and one or more private attributes z= [symbol] wherein t represents an integer index; sampling random values rₓ for setting values u_{t,init} comprising rₓ, padded with zeroes and appended with a randomized encoding of the index t, and computing FE ciphertext FE.CT_{t,init} for the value u_{t,init}; computing coefficients cₜ comprising x, rₓ and setting values uₜ comprising rₓ, cₜ, padded with zeroes and appended with a randomized encoding of the index t, and computing FE ciphertext FE.CTₜ for the value uₜ; setting values ũₜ comprising rₓ, zₜ, padded with zeroes and appended with a randomized encoding of the index t, and computing FE ciphertext [symbol] for the value ũₜ; and outputting the ciphertext CT as {FE.CT_{t,init}, FE.CTₜ}, { [symbol] } and storing the output in an electronic encryption device storage unit.

Some embodiments further include a decryption method, the decryption method including: receiving the function M and the secret key SK_{M} for function M; receiving one or more public attributes x and a ciphertext CT for x; retrieving {FE.SK_{t,init}, FE.SKₜ}, { [symbol] } from SK_{M} and retrieving {FE.CT_{t,init}, FE.CTₜ}, { [symbol] } from CT; retrieving sub-functions Mₜ from the function M; upon verifying [symbol] ⊆ [symbol] proceeds as follows:

decrypting FE.CT_{t,init} by running the decryption algorithm of FE using the secret key FE.SK_{t,init} and get a value [symbol] ᵢₙᵢₜ; decrypting FE.CTₜ by running the decryption algorithm of FE using the secret key FE.SKₜ and get a value [symbol] ; decrypting [symbol] by running the decryption algorithm of FE using the secret key [symbol] and get a value [symbol] ; running an evaluation algorithm of a garbling procedure using the values [symbol] ᵢₙᵢₜ, [symbol] , [symbol] and the one or more public attributes x and the sub-function Mₜ, and get a value d; and recovering the functional value μ from d and outputting the value μ as the plaintext and storing the output in an electronic decryption device storage unit.

In some further embodiments, a first FE key pair (FE.MPK, FE.MSK) is for encrypting a public part of attributes and the second FE key pair ( [symbol] , [symbol] ) is for use in encrypting a private part of the attributes.

### BRIEF DESCRIPTION OF THE DRAWINGS

The accompanying drawings, which are included to provide further understanding and are incorporated in and constitute a part of this specification, illustrate disclosed embodiments, and together with the description, serve to explain the principles of the disclosed embodiments. In the drawings:

FIG. 1 illustrates an encryption system in an embodiment of the invention including a setup algorithm, an encryption algorithm, a key generation algorithm, and a decryption algorithm.

FIG. 2 illustrates an example system architecture with a functional encryption server, data owner, data user, and trusted authority.

FIG. 3 illustrates an example computer system architecture for implementing the claimed systems and methods.

FIG. 4 illustrates further details of an example computer system architecture for implementing the claimed systems and methods.

### DETAILED DESCRIPTION

Herein, we formally define and construct a FE scheme for unbounded AWS (UAWS) functionality where the setup only depends on the security parameter of the system and the weight functions are modeled as Turing machines. The disclosed FE scheme supports both public and private attributes of arbitrary lengths. In particular, the public parameters of the system are completely independent of the lengths of attribute pairs. Moreover, the ciphertext size is compact meaning that it does not grow with the number of occurrences of a specific attribute in the weight functions which are represented as Logspace Turing machines. The scheme is adaptively simulation secure against the release of an unbounded (polynomial) number of secret keys both before and after the challenge ciphertext. As noted in other work, simulation security is the best possible and the most desirable model for FE. Moreover, simulation-based security also captures indistinguishability-based security but the converse does not hold in general.

The disclosed FE for UAWS is proven secure in the standard model based on the symmetric external Diffie-Hellman (SXDH) assumption in the asymmetric prime-order pairing groups.

Viewing IPFE as a special case of FE for AWS, we also obtain the first adaptively simulation secure IPFE scheme for unbounded length vectors (UIPFE), i.e., the length of the vectors is not fixed in setup. Observe that all prior simulation secure IPFE could only support bounded length vectors, i.e., the lengths must be fixed in the setup. On the other hand, the only known construction of UIPFE is proven secure in the indistinguishability-based model.

### 1 Technical Overview

An overview of techniques for achieving a FE scheme for AWS functionality which supports the uniform model of computations is disclosed. We consider prime-order bilinear pairing groups ( [symbol] ₁, [symbol] ₂, [symbol] _{T}, g₁, g₂, e) with a generator g_{T}=e(g₁, g₂) of [symbol] _{T} and denote [symbol] ᵢ by an element gᵢ^{a}∈ [symbol] ᵢ for i∈{1, 2, T}. For any vector z, the k-th entry is denoted by z[k] and [n] denotes the set {1, . . . , n}.

The unbounded AWS Functionality. In this work, we consider an unbounded FE scheme for the AWS functionality for Logspace Turing machines (or the class of L), in shorthand it is written as UAWS^{L}. More specifically, the setup only takes input the security parameter of the system and is independent of any other parameter, e.g., the lengths of the public and private attributes. UAWS^{L} generates secret keys [symbol] for a tuple of Turing machines denoted by M= [symbol] such that the index set [symbol] contains any arbitrary number of Turing machines Mₖ∈L. The ciphertexts are computed for a pair of public-private attributes (x, z) whose lengths are arbitrary and are decided at the time of encryption. Precisely, the public attribute x of length N comes with a polynomial time bound T=poly(N) and a logarithmic space bound S, and the private attribute z is an integer vector of length n. At the time of decryption, if [symbol] ⊆[n] then it reveals an integer value [symbol] Mₖ(x)z[k]. Since Mₖ(x) is binary, we observe that the summation selects and adds the entries of z for which the corresponding Turing machine accepts the public attribute x. An appealing feature of the functionality is that the secret key [symbol] can decrypt ciphertexts of unbounded length attributes in unbounded time/(logarithmic) space bounds. In contrast, existing FE for AWSs are designed to handle non-uniform computations that can only handle attributes of bounded lengths and the public parameters grows linearly with the lengths. Next, we describe the formulation of Turing machines in L considered in UAWS^{L}.

Turing machines Formulation. We introduce the notations for Logspace Turning machines (TM) over binary alphabets. A Turing machine M=(Q, y_{acc}, δ) consists of Q states with the initial state being 1 and a characteristic vector y_{acc}∈{0, 1}^{Q} of accepting states and a transition function δ. When an input (x, N, T, S) with length N and time, space bounds T, S is provided, the computation of M|_{N,T,S}(x) is performed in T steps passing through configurations (x, (i, j, W, q) where i∈[N] is the input tape pointer, j∈[S] is the work tape pointer, W∈{0, 1}^{S} the content of work tape, and q∈[Q] the state under consideration. The initial internal configuration is (1, 1, 0_{S}, 1) and the transition function δ determines whether, on input x, it is possible to move from one internal configuration (i, j, W, q) to the next ((i′, j′, W′, q′)), namely if δ(q, x[i], W[j])=(q′, w′, Δi, Δj). In other words, the transition function δ on input state q, an input bit x[i] and an work tape bit W[j], outputs the next state q′, the new bit w′ overwriting w=W[j] by w′=W′[j] (keeping W[j″]=W′[j″] for all j≠j″), and the directions Δi, Δj∈{0, ±1} to move the input and work tape pointers.

Our construction of adaptively simulation secure UAWS^{L} depends on two building blocks: AKGS for Logspace Turing machines, an information-theoretic tool and slotted IPFE, a computation tool. We only need a bounded slotted IPFE, meaning that the length of vectors of the slotted IPFE is fixed in the setup, and we only require the primitive to satisfy adaptive indistinguishability based security. Hence, our work shows how to (semi-) generically bootstrap a bounded IPFE to an unbounded FE scheme beyond the inner product functionality.

### 2 Preliminaries

In this section, we provide the necessary definitions and backgrounds that will be used in the sequence.

Notations. We denote by λ the security parameter that belongs to the set of natural number [symbol] and 1^{λ} denotes its unary representation. We use the notation s←S to indicate the fact that s is sampled uniformly at random from the finite set S. For a distribution χ, we write x←χ to denote that x is sampled at random according to distribution χ. A function negI: [symbol] ← [symbol] is said to be a negligible function of λ, if for every c∈N there exists a λ_{c}∈N such that for all λ>λ_{c}, |negI(λ)|λ^{-c}.

Let Expt be an interactive security experiment played between a challenger and an adversary, which always outputs a single bit. We assume that

$${Expt}_{𝒜}^{C}$$

is a function of λ and it is parametrized by an adversary [symbol] and a cryptographic protocol C. Let

$${Expt}_{𝒜}^{C , 0} and {Expt}_{𝒜}^{C , 1}$$

be two such experiment. The experiments are computationally/statistically indistinguishable if for any PPT/computationally unbounded adversary [symbol] there exists a negligible function negI such that for all λ∈N,

$${Adv}_{𝒜}^{C} ( λ ) = \vert Pr [ 1 ← {Expt}_{𝒜}^{C , 0} ( {1}^{λ} ) ] - Pr [ 1 ← {Expt}_{𝒜}^{C , 1} ( {1}^{λ} ) ] \vert < negl ( λ )$$

We write

$${Expt}_{𝒜}^{C , 0} {\approx }^{c} {Expt}_{𝒜}^{C , 1}$$

if they are computationally indistinguishable (or simply indistinguishable). Similarly,

$${Expt}_{𝒜}^{C , 0} {\approx }^{s} {Expt}_{𝒜}^{C , 1}$$

means statistically indistinguishable and

$${Expt}_{𝒜}^{C , 0} ≡ {Expt}_{𝒜}^{C , 1}$$

means they are identically distributed.

Sets and Indexing. For n∈N, we denote [n] the set {1, 2, . . . , n} and for n, m∈N with n<m, we denote [n, m] be the set {n, n+1, . . . , m}. We use lowercase boldface, e.g., v, to denote column vectors in

$${ℤ}_{p}^{n}$$

uppercase Nutrace, e.g., M, to derive matrices in

$${ℤ}_{p}^{n \times m}$$

for p, n, m∈N. The i-th component of a vector v∈

$${ℤ}_{p}^{n}$$

is written as v[i] and the (i, j)-th element of a matrix

$$M ∈ {ℤ}_{p}^{n \times m}$$

is denoted by M[i, j]. The transpose of a matrix M is denoted by M^{T} such that M^{T}[i, j]=M [j, i]. To write a vector of length n with all zero elements, we write 0ₙ or simply 0 when the length is clear from the context. Let u, v∈

$${ℤ}_{p}^{n} ,$$

then the inner product between the vectors is denoted as u·v=u^{T}v=Σ_{i∈[n]} u[i]v[i]∈ [symbol] ₚ. We define generalized inner product between two vectors

$$u ∈ {ℤ}_{p}^{{ℐ}_{1}} , v ∈ {ℤ}_{p}^{{ℐ}_{2}}$$

by u·v= [symbol] u[i]v[i].

Tensor Products. Let

$$u ∈ {ℤ}_{p}^{{ℐ}_{1}} and v ∈ {ℤ}_{p}^{{ℐ}_{2}}$$

be two vectors, their tensor product w=u⊗v is a vector in [symbol] with entries defined by w[(i, j)]=u[i]v[i]. For two matrices

$${M}_{1} ∈ {ℤ}_{p}^{{ℐ}_{1} \times {ℐ}_{2}} and {M}_{1} ∈ {ℤ}_{p}^{{ℐ}_{1}^{′} \times {ℐ}_{2}^{′}} ,$$

their tensor product M=M=M₁⊗M₂ is a matrix in [symbol] with entries defined by M [(i₁, i′₁), (i₂, i′₂)]=M₁[i₁, i₂]M₂[i′₁, i′₂].

Currying. Currying is the product of partially applying a function or specifying part of the indices of a vector/matrices, which yields another function with fewer arguments or another vector/matrix with fewer indices. We use the usual syntax for evaluating a function or indexing into a vector/matrix, except that unspecified variables are represented by “␣”. For example, let M∈ [symbol] and i₁∈ [symbol] , j₂∈ [symbol] , then M(i₁, ␣), (␣, j₂)] is a matrix

$$N ∈ {ℤ}_{p}^{[ {ℐ}_{2} ] \times [ {𝒥}_{2} ]}$$

such that N[i₂, j₁]=M[(i₁, i₂), (j₁, j₂)] for all i₂∈ [symbol] , j₁∈ [symbol] .

Coefficient Vector Let

$$f : {ℤ}_{p}^{ℐ} \to {ℤ}_{p}$$

be an affine function with coefficient vector

$$f ∈ {ℤ}_{p}^{𝒮}$$

for S={const}∪{coefᵢ|i∈ [symbol] }. Then for any

$$x ∈ {ℤ}_{p}^{ℐ} ,$$

we have ƒ(x)=f[const]+ [symbol] f[coefᵢ]x[i].

### 2.1 Bilinear Groups and Hardness Assumptions

We use a pairing group generator [symbol] that takes as input 1^{λ} and outputs a tuple G=( [symbol] ₁, [symbol] ₂, [symbol] _{T}, g₁, g₂, e) where [symbol] ₁, [symbol] 2, [symbol] _{T} are groups of prime order p=p(λ) and gᵢ is a generator of the group [symbol] ᵢ for i∈{1, 2}. The map e: [symbol] ₁× [symbol] ₂→ [symbol] _{T} satisfies the following properties:
bilinear:

$$e ( {g}_{1}^{a} , {g}_{2}^{b} ) = {e ( {g}_{1} , {g}_{2} )}^{a b}$$

for all a, b∈ [symbol] ₚ.
non-degenerate: e( [symbol] , [symbol] ) generates [symbol] _{T}.

The group operations in [symbol] ᵢ for i∈{1, 2, T} and the map e are efficiently computable in deterministic polynomial time in the security parameter λ. For a matrix A and each i∈{1, 2, T}, we use the notation [A]ᵢ to denote

$${g}_{i}^{A}$$

where the exponentiation is element-wise. The group operation is written additively while using the bracket notation, i.e. [A+B]ᵢ=[A]ᵢ+[B]ᵢ for matrices A and B. Observe that, given A and [B]ᵢ, we can efficiently compute [AB]ᵢ=A·[B]ᵢ. We write the pairing operation multiplicatively, i.e. e([A]₁, [B]₂)=[A]₁[B]₂=[AB]_{T}.

Assumption 2.1 (Symmetric External Diffie-Hellman Assumption) We say that the SXDH assumption holds in a pairing group G=( [symbol] ₁, [symbol] ₂, [symbol] _{T}, g₁, g₂, e) of order p, if the DDH assumption holds in [symbol] ᵢ, i.e., {[a]ᵢ, [b]ᵢ, [ab]ᵢ}≈{[a]ᵢ, [b]ᵢ, [c]ᵢ} if for i∈{1, 2, T} and a, b, c← [symbol] ₚ.

### 2.2 Turing Machine Formulation

In this subsection, we describe the computational model, which is Turing machines with a read-only input and a read-write work tape. This type of Turing machines are used to handle decision problems belonging to space-bounded complexity classes such as Logspace predicates. We define below Turing machines with time complexity T and space complexity S. The Turing machine can either accept or reject an input string within this time/space bound. We also stick to the binary alphabet for the shake of simplicity.

### Definition 2.1 (Turing Machine with Time/Space Bound Computation)

A (deterministic) Turing machine over {0, 1} is a tuple M=(Q, y_{acc}, δ), where Q≥1 is the number of states (we use [Q] as the set of states and 1 as the initial state), y_{acc}∈{0, 1}^{Q} indicates whether each state is accepting, and

$$δ : [ Q ] \times \{ 0 , 1 \} \times \{ 0 , 1 \} \to [ Q ] \times \{ 0 , 1 \} \times \{ 0 , \pm 1 \} \times \{ 0 , \pm 1 \} , ( q , x , w ) ↦ ( {q}^{′} , {w}^{′} , Δ i , Δ j )$$

is the state transition function, which, given the current state q, the symbol x on the input tape under scan, and the symbol w on the work tape under scan, specifies the new state q′, the symbol w′ overwriting w, the direction Δi to which the input tape pointer moves, and the direction Δj to which the work tape pointer moves. The machine is required to hang (instead of halting) once it reaches on the accepting state, i.e., for all q∈[Q] such that y_{acc}[g]=1 and all x, w∈{0, 1}, it holds that δ(q, x, w)=(q, w, 0, 0).

For input length N≥1 and space complexity bound S>1, the set of internal configurations of M is

$${𝒞}_{M , N , S} = [ N ] \times [ S ] \times {\{ 0 , 1 \}}^{S} \times [ Q ] ,$$

where (i, j, W, q)∈ [symbol] _{M,N,S} specifies the input tape pointer i∈[N], the work tape pointer j∈[S], the content of the work tape W∈{0, 1}^{S} and the machine state q∈[Q].

For any bit-string x∈{0, 1}^{N} for N≥1 and time/space complexity bounds T, S≥1, the machine M accepts x within time T and space S if there exists a sequence of internal configurations (computation path of T steps) c₀, . . . , c_{T}∈ [symbol] _{M,N,S} with cₜ=(iₜ, jₜ, Wₜ, qₜ) such that

$$\begin{matrix}{i}_{0} = 1 , {j}_{0} = 1 , {W}_{0} = {0}_{S} , {q}_{0} = 1 ( initial configuration ) , \\ for 0 \leq t < T \{ \begin{matrix}δ ( {q}_{t} , x [ {i}_{t} ] , {W}_{t} [ {j}_{t} ] ) = ( {q}_{t + 1} , {W}_{t + 1} [ {j}_{t} ] , {i}_{t + 1} - {i}_{t} , {j}_{t + 1} - {j}_{t} ) , \\ {W}_{t + 1} [ j ] = {W}_{t} [ j ] for all j \neq {j}_{t} ( valid transitions ) ; \\ {y}_{a c c} [ {q}_{T} ] = 1 ( accepting ) .\end{matrix}\end{matrix}$$

Denote by M|_{N,T,S} the function {0, 1}^{N}→{0, 1} mapping x to whether M accepts x in time T and space S. Define TM={M| M is a Turing machine} to be the set of all Turing machines.

Note that, the above definition does not allow the Turing machines moving off the in-put/work tape. For instance, if δ specifies moving the input pointer to the left/right when it is already at the leftmost/rightmost position, there is no valid next internal configuration. This type of situation can be handled by encoding the input string. The problem of moving off the work tape to the left can be managed similarly, however, moving off the work tape to the right is undetectable by the machine, and this is intended due to the space bound. That is, when the space bound is violated, the input is silently rejected.

### 2.3 Functional Encryption for Unbounded Attribute-Weighted Sum for Turing Machines

We formally present the syntax of FE for unbounded attribute-weighted sum (AWS) and define adaptive simulation security of the primitive. We consider the set of all Turing machines TM={M| M is a Turing machine} with time bound T and space bound S.

Definition 2.2 (The AWS Functionality for Turing machines) For any n, N∈ [symbol] , the class of attribute-weighted sum functionalities is defined as

$$\{ ( ( x ∈ {\{ 0 , 1 \}}^{N} , {1}^{T} , {1}^{{2}^{S}} ) , 𝓏 ∈ {ℤ}_{p}^{n} ) ↦ {M ( x )}^{⊤} 𝓏 = {\sum }_{k ∈ {ℐ}_{M}} 𝓏 [ k ] \cdot {M}_{k} ( x ) \vert \begin{matrix}N , T , S \geq 1 , \\ {M}_{k} ∈ TM ∀ k ∈ [ n ] , \\ {ℐ}_{M} ⊆ [ n ] with \vert {ℐ}_{M} \vert \geq 1\end{matrix} \}$$

Definition 2.3 (Functional Encryption for Attribute-Weighted Sum) An unbounded-slot FE for unbounded attribute-weighted sum associated to the set of Turing machines TM and the message space [symbol] consists of four PPT algorithms defined as follows:

Setup (1^{λ}) The setup algorithm takes as input a security parameter and outputs the master secret-key MSK and the master public-key MPK.

KeyGen(MSK, (M, [symbol] )) The key generation algorithm takes as input MSK and a tuple of Turing machines M=(Mₖ)_{K∈I}_{_{M}}. It outputs a secret-key [symbol] and make (M, [symbol] ) available publicly.

Enc(MPK, (xᵢ, 1^{T}^{ᵢ}, 1^{S}^{ᵢ}), [symbol] The encryption algorithm takes as input MPK and a message consisting of [symbol] number of public-private pair of attributes (xᵢ, zᵢ)∈ [symbol] such that the public attribute xᵢ∈{0, 1}^{N}^{ᵢ} for some Nᵢ≥1 with time and space bounds given by Tᵢ, Sᵢ≥1, and the private attribute

$${𝓏}_{i} ∈ {ℤ}_{p}^{{n}_{i}} .$$

It outputs a ciphertext CT₍ₓ_{ᵢ}_{,T}_{ᵢ}_{,S}_{ᵢ}₎ and make (xᵢ, Tᵢ, [symbol] available publicly.

Dec(( [symbol] ), (M, [symbol] )), (CT₍ₓ_{ᵢ}_{,T}_{ᵢ}_{,S}_{ᵢ}₎, (xᵢ, Tᵢ, [symbol] ) The decryption algorithm takes as input [symbol] along with the tuple of Turing machines and index sets (M, [symbol] ), and a ciphertext CT₍ₓ_{ᵢ}_{,T}_{ᵢ}_{,S}_{ᵢ}₎ along with a collection of associated public attributes (xᵢ, Tᵢ, [symbol] . It outputs a value in [symbol] ₚ or ⊥.

Definition 2.4 (Adaptive Simulation Security) Let (Setup, KeyGen, Enc, Dec) be an unbounded-slot FE for unbounded attribute-weighted sum for TM and message space [symbol] . The scheme is said to be (Φₚᵣₑ, Φ_{CT}, Φₚₒₛₜ)-adaptively simulation secure if for any PPT adversary [symbol] making at most Φ_{CT} ciphertext queries and Φₚᵣₑ, Φₚₒₛₜ secret key queries before and after the ciphertext queries respectively, we have

$$E x p {t}_{𝒜 , real}^{UAWS} ( {1}^{λ} ) {\approx }^{c} {Expt}_{𝒜 , ideal}^{UAWS} ( {1}^{λ} ) ,$$

where the experiments are defined as follows. Also, an unbounded-slot FE for attribute-weighted sums is said to be (poly, Φ_{CT}, poly)-adaptively simulation secure if it is (Φₚᵣₑ, Φ_{CT}, Φₚₒₛₜ)-adaptively simulation secure as well as Φₚᵣₑ and Φₚₒₛₜ are unbounded polynomials in the security parameter λ.

| | |
|---|---|
| ${Expt}_{𝒜 , real}^{UAWS} ( {1}^{λ} )$ | [symbol] _{KeyGen(MSK,·)} |
| 1. [symbol] ← [symbol] ; | 1. input: (M, [symbol] ) |
| 2. (MSK, MPK) ← Setup(1^{λ}); | 2. output: [symbol] |
| $3. ( {( ( {x}_{i} , {1}^{{T}_{i}} , {1}^{{S}_{i}} ) , {z}_{i} ∈ {ℤ}_{p}^{{n}_{i}} )}_{i ∈ [ 𝒩 ]} ) ← {𝒜}^{{𝒪}_{KeyGen ( MSK , \cdot )}} ( MPK ) ;$ | [symbol] _{KeyGen*}_{₀}_{(MSK*,·)} |
| 4. CT₍ₓ_{ᵢ}_{,T}_{ᵢ}_{,S}_{ᵢ}₎ ← Enc(MPK, ((xᵢ, 1^{T}^{ᵢ}, 1^{S}^{ᵢ}), [symbol] ; | 1. input: (M_{φ}, [symbol] ) for φ ∈ [Φₚᵣₑ] |
| 5. return [symbol] (MPK, CT) | 2. output: [symbol] |
| ${Expt}_{𝒜 , ideal}^{UAWS} ( {1}^{λ} )$ | Enc* (MPK, MSK*, (xᵢ, 1^{T}^{ᵢ}, 1^{S}^{ᵢ}, [symbol] ,·) |
| 1. 1^{N} ← A(1^{λ}); | 1. input: [symbol] = {(M_{φ}, [symbol] ), [symbol] M_{φ} (xᵢ)^{T} zᵢ: |
| 2. (MSK*, MPK) ← Setup* (1^{λ}2, 1^{N}); | φ ∈ [Φₚᵣₑ] |
| $3. ( {( ( {x}_{i} , {1}^{{T}_{i}} , {1}^{{S}_{i}} ) , {z}_{i} ∈ {ℤ}_{p}^{{n}_{i}} )}_{i ∈ [ 𝒩 ]} ) ← {𝒜}^{{𝒪}_{{KeyGen}_{0}^{*} ( {MSK}^{*} , \cdot )}} ( MPK )$ | 2. output: CT₍ₓ_{ᵢ}_{,T}_{ᵢ}_{,S}_{ᵢ}₎ |
| 4. CT₍ₓ_{ᵢ}_{,T}_{ᵢ}_{,S}_{ᵢ}₎ ← Enc*(MPK, MSK*, (xᵢ, 1^{T}^{ᵢ}, 1^{S}^{ᵢ}, [symbol] , [symbol] ); | [symbol] |
| 5. return [symbol] (MPK, CT₍ₓ_{ᵢ}_{,T}_{ᵢ}_{,S}_{ᵢ}₎) | $1. input : ( {M}_{ϕ} , {ℐ}_{{M}_{ϕ}} ) , {\sum }_{i ∈ 𝒩} {{M}_{ϕ} ( {x}_{i} )}^{T} {z}_{i} for ϕ ∈$ |
| | [Φₚₒₛₜ] |
| | 2. output: [symbol] |

### 2.4 Function-Hiding Slotted Inner Product Functional Encryption

Definition 2.5 (Slotted Inner Product Functional Encryption) Let G=( [symbol] ₁, [symbol] ₂, [symbol] _{T}, g₁, g₂, e) be a tuple of pairing groups of prime order p. A slotted inner product functional encryption (IPFE) scheme based on G consists of 5 efficient algorithms:

IPFE.Setup(1^{λ}, S_{pub}, Sₚᵣᵢᵥ) The setup algorithm takes as input a security parameter λ and two disjoint index sets, the public slot S_{pub} and the private slot Sₚᵣᵢᵥ. It outputs the master secret-key IPFE.MSK and the master public-key IPFE.MPK. Let S=S_{pub}∪Sₚᵣᵢᵥ be the whole index set and |S|, |S_{pub}|, |Sₚᵣᵢᵥ| denote the number of indices in S, S_{pub} and Sₚᵣᵢᵥ respectively.

IPFE.KeyGen(IPFE.MSK, [v]₂) The key generation algorithm takes as input IPFE.MSK and a vector

$${〚 υ 〛}_{2} ∈ {𝔾}_{2}^{\vert S \vert} .$$

It outputs a secret-key IPFE.SK for

$$υ ∈ {ℤ}_{p}^{\vert S \vert} .$$

IPFE.Enc(IPFE.MSK, [u]₁) The encryption algorithm takes as input IPFE.MSK and a vector

$${〚 u 〛}_{1} ∈ {𝔾}_{1}^{\vert S \vert} .$$

It outputs a ciphertext IPFE.CT for

$$u ∈ {ℤ}_{p}^{\vert S \vert} .$$

IPFE.Dec(IPFE.SK, IPFE.CT) The decryption algorithm takes as input a secret-key IPFE.SK and a ciphertext IPFE.CT. It outputs an element from [symbol] _{T}.

IPFE.SlotEnc(IPFE.MPK, [u]₁) The slot encryption algorithm takes as input IPFE.MPK and a vector

$${〚 u 〛}_{1} ∈ {𝔾}_{1}^{\vert {S}_{pub} \vert} .$$

It outputs a ciphertext IPFE.CT for

$$( u \vert \vert {0}_{\vert {S}_{priv} \vert} ) ∈ {ℤ}_{p}^{\vert S \vert} .$$

### 2.5 Arithmetic Key Garbling Scheme for Turing Machines

The notion of arithmetic key garbling scheme (AKGS) is an information theoretic primitive, inspired by randomized encodings and partial garbling schemes. It garbles a function

$$f : {ℤ}_{p}^{n} \to {ℤ}_{p}$$

(possibly of size (+1) along with two secrets z, β∈ [symbol] ₚ and produces affine label functions L₁, . . . , Lₘ₊₁:

$${ℤ}_{p}^{n} \to {ℤ}_{p} .$$

Given ƒ, an input

$$x ∈ {ℤ}_{p}^{n}$$

and the values L₁(x), . . . , Lₘ₊₁(x), there is an efficient algorithm which computes zƒ(x)+β without revealing any information about z and β. We define AKGS for the function class

$$ℱ = \{ M {\vert}_{N , T , S} : {ℤ}_{p}^{N} \to {ℤ}_{p} , N , T , S \geq 1 , p prime \}$$

for the set of all time/space bounded Turing machine computations.

In this section, we build a secret-key, 1-slot FE scheme for the unbounded attribute-weighted sum functionality in L. At a high level, the scheme satisfies the following properties:
The setup is independent of any parameters, other than the security parameter λ. Specifically, the length of vectors and attributes, number of Turing machines and their sizes are not fixed a-priori during setup. These parameters are flexible and can be chosen at the time of key generation or encryption.
A secret key is associated with a tuple (M, [symbol] ), where M= [symbol] is a tuple of Turing machines with indices k from an index set I_{M}. For each k∈ [symbol] , Mₖ∈L, i.e., Mₖ is represented by a deterministic log-space bounded Turing machine (with an arbitrary number of states).
Each ciphertext encodes a tuple of public-private attributes (x, z) of lengths N and n respectively. The runtime T and space bound S for all the machines in M are associated with x which is the input of each machine Mₖ.
Finally, decrypting a ciphertext CTₓ that encodes (x, z) with a secret key [symbol] that is tied to (M, [symbol] ) reveals the value [symbol] z[k]. Mₖ(x) whenever [symbol] ⊆[n].

We build an FE scheme for the functionality sketched above (also described in Definition 2.2) and prove it to be simulation secure against a single ciphertext and secret key query, where the key can be asked either before or after the ciphertext query. Accordingly, we denote the scheme as

$$SK - {UAWS}_{( 1 , 1 , 1 )}^{L} = ( Setup , KeyGen , Enc , Dec ) ,$$

where the index (1, 1, 1) represents in order the number of secret keys, ciphertexts and slots supported. Below, we list the ingredients for our scheme.
1. IPFE=(IPFE.Setup, IPFE.KeyGen, IPFE.Enc, IPFE.Dec): a secret-key, function-hiding IPFE based on G, where G=( [symbol] ₁, [symbol] ₂, [symbol] _{T}, g₁, g₂, e) is pairing group tuple of prime order p.
2. AKGS=(Garble, Eval): a special piecewise-secure AKGS for the function class

$${ℳ = \{ M \vert}_{N , T , S} : {ℤ}_{p}^{N} \to {ℤ}_{p} \vert M ∈ TM , N , T , S \geq 1 , p prime \}$$

describing the set of time/space bounded Turing machines. In our construction, the Garble algorithm would run implicitly under the hood of IPFE and thus, it is not invoked directly in the scheme.

### 3.1 The Construction

$$SK - UAW {S}_{( 1 , 1 , 1 )}^{L} = ( Setup , KeyGen , Enc , Dec )$$

is described below.
Setup (1^{λ}): On input the security parameter, fix a prime integer p∈ [symbol] and define the slots for two IPFE master secret keys as follows:

$${𝒮}_{1 - UAWS} = \{ {index}_{1} , {index}_{2} , init , rand , {rand}^{temp} , {rand}^{comp} , {rand}^{temp , comp} , \\ acc , sim , {sim}^{temp} , {sim}^{comp} \} ⋃ \{ {tb}_{τ} , {tb}_{τ}^{temp} , {tb}_{τ}^{comp} , {tb}_{τ}^{temp , comp} \vert τ ∈ 𝒯 \} ,$$

$${𝒮}_{1 - UAWS} = \{ {index}_{1} , {index}_{2} , init , \\ rand , {rand}^{temp} , {rand}^{temp , comp} , acc , {acc}^{temp} , sim , {sim}^{temp} \} .$$

Finally, it returns MSK=(IPFE.MSK, IPFE. [symbol] ).
KeyGen (MSK, (M, [symbol] )): On input the master secret key MSK=(IPFE.MSK, IPFE. [symbol] ) and a function tuple M= [symbol] indexed w.r.t. an index set [symbol] ⊂ [symbol] of arbitrary size, parse Mₖ=(Qₖ, yₖ, δₖ)∈TM ∇k∈ [symbol] and sample the set of elements

$${\{ {β}_{k} ← {ℤ}_{p} \vert {\sum }_{k} {β}_{k} = 0 mod p \}}_{k ∈ {ℐ}_{M}}$$

For all k∈ [symbol] , do the following:
1. For Mk=(Qₖ, yₖ, δₖ), compute its transition blocks M_{k,τ}∈{0, 1}^{Q}^{ₖ}^{×Q}^{ₖ}, ∇τ∈ [symbol] .
2. Sample independent random vectors

$${r}_{k , f} ← {ℤ}_{p}^{{Q}_{k}}$$

and a random element πₖ∈ [symbol] ₚ.

3. For the following vector v_{k,init}, compute a secret key IPFE.SK_{k,init}←IPFE.KeyGen (IPFE.MSK, [symbol] v_{k,init} [symbol] ₂):

| | | | | | | | the other |
|---|---|---|---|---|---|---|---|
| vector | index₁ | index₂ | init | rand | acc | tb_{τ} | indices |
| v_{k, init} | πₖ | k · πₖ | r_{k, f}[1] | 0 | βₖ | 0 | 0 |

4. For each q∈[Qₖ], compute the following secret keys

$$IPFE . {SK}_{k , q} ← IPFE . KeyGen ( IPFE . MSK , {〚 {v}_{k , q} 〛}_{2} ) and \\ ← IPFE . KeyGen ( IPFE . , {〚 {\tilde{v}}_{k , q} 〛}_{2} ) ,$$

where the vectors v_{k,q}, \tilde{v}_{k,q} are defined as follows:

| | | | | | | | the other |
|---|---|---|---|---|---|---|---|
| vector | index₁ | index₂ | init | rand | acc | tb_{τ} | indices |
| v_{k, q} | πₖ | k · | 0 | −r_{k, f}[q] | 0 | (M_{k, τ}r_{k, f}) | 0 |
| | | πₖ | | | | [q] | |

| | | | | | the other |
|---|---|---|---|---|---|
| vector | index₁ | index₂ | rand | acc | indices |
| \tilde{v}_{k, q} | πₖ | k · πₖ | −r_{k, f}[q] | yₖ[q] | 0 |

Finally, it returns the secret key as
[symbol] =((M, I_{M}), {IPFE.SK_{k,init}, {IPFE.SK_{k,q}, [symbol] ).
Enc(MSK, (x, 1^{T}, 1²^{^{S}}), z): On input the master secret key MSK=(IPFE.MSK, IPFE. [symbol] ), a public attribute x∈{0, 1}^{N} for some arbitrary N≥1 with time and space complexity bounds given by T, S≥1 (as 1^{T}, 1²^{^{S}}) respectively, and the private attribute

$$z ∈ {ℤ}_{p}^{n}$$

for some arbitrary n≤1, n does the following:
   1. Sample a random vector

$${r}_{x} ← {ℤ}_{p}^{[ 0 , T ] \times [ N ] \times [ S ] \times {\{ 0 , 1 \}}^{S}} .$$

2. For each k∈[n], do the following:
   (a) Sample a random element

$${ρ}_{k} ← {ℤ}_{p} .$$

(b) Compute a ciphertext IPFE.CT_{k,init}←IPFE.Enc(IPFE.MSK, [u_{k,init}]₁) for the vector v_{k,init}:

| | | | | | | | the other |
|---|---|---|---|---|---|---|---|
| vector | index₁ | index₂ | init | rand | acc | tb_{τ} | indices |
| u_{k, init} | −k · ρₖ | ρₖ | rₓ[(0, 1, 1, | 0 | 1 | 0 | 0 |
| | | | 0_{S})] | | | | |

(c) For all t∈[T], i∈[N], j∈[S], W∈{0, 1}^{S}, do the following:
   (i) Compute the transition coefficients c_{τ}(x; t, i, j, W; rₓ), ∇τ∈ [symbol] using rₓ.
   (ii) Compute the ciphertext IPFE.CT_{k,t,i,j}w←IPFE.Enc(IPFE.MSK, [u_{k,t,i,j},w]₁) for the vector u_{k,t,i,j}w:

| | | | | | | | the |
|---|---|---|---|---|---|---|---|
| | | | | | | | other |
| vector | index₁ | index₂ | init | rand | acc | tb_{τ} | indices |
| u_{k, t, i, j, W} | −k · | ρₖ | 0 | rₓ[(t − 1, | 0 | c_{τ}(x; t, | 0 |
| | ρₖ | | | i, j, W)] | | i, j, W; rₓ) | |

(d) For t=T+1, compute the ciphertext [symbol] _{k,T+1,i,j}w← [symbol] .Enc (IPFE. [symbol] , [symbol] ũ_{k,T+1,i,j}w [symbol] ₁) for the vector ũ_{k,T+1,i,j}w:

| | | | | | the other |
|---|---|---|---|---|---|
| vector | index₁ | index₂ | rand | acc | indices |
| ũ_{k, T+1, i, j}, w | −k · ρₖ | ρₖ | rₓ[(T, i, j, W)] | z[k] | 0 |

3. Finally, it returns the ciphertext as

$$C {T}_{( x , T , S )} = ( ( x , T , S ) , {\{ IPFE . {CT}_{k , init} , {\{ IPFE . {CT}_{k , t , i , j , W} \}}_{t ∈ [ T ]} , \\ {k , T + 1 , i , j , W}_{} \}}_{k ∈ [ n ] , i ∈ [ N ] , j ∈ [ S ] , W ∈ {\{ 0 , 1 \}}^{S}} ) .$$

Dec(SK_{(M,I}_{_{M}}₎; CT_{(x,T,S)}: On input a secret key [symbol] and a ciphertext CT_{(x,T,S)}, do the following:
   1. Parse [symbol] and CT_{(x,T,S)} as follows:

$${SK}_{( M , {ℐ}_{M} )} = ( ( {( {M}_{k} )}_{k ∈ {ℐ}_{M}} , {ℐ}_{M} ) , {\{ IPFE . {SK}_{k , init} , {\{ IPFE . {SK}_{k , q} , {k , q}_{} \}}_{q ∈ [ {Q}_{k} ]} \}}_{k ∈ {ℐ}_{M}} ) ,$$

$${M}_{k} = ( {Q}_{k} , {y}_{k} , {δ}_{k} ) ,$$

$${CT}_{( x , T , S )} = ( ( x , T , S ) , {\{ IPFE . {CT}_{k , init} m {\{ IPFE . {CT}_{k , t , i , j , W} \}}_{t ∈ [ T ]} , \\ {k , T + 1 , u , j , W}_{} \}}_{k ∈ [ n ] , i ∈ [ N ] , j ∈ [ S ] , W ∈ {\{ 0 , 1 \}}^{S}} ) , x ∈ {\{ 0 , 1 \}}^{N} .$$

2. Output ⊥, if [symbol] ⊆[n]. Else, select the sequence of ciphertexts for the indices k∈ [symbol] as

$$C {T}_{( x , T , S )} = ( ( x , T , S ) , {\{ IPFE . {CT}_{k , init} , {\{ IPFE . {CT}_{k , t , i , j , W} \}}_{t ∈ [ T ]} , \\ {k , T + 1 , i , j , W}_{} \}}_{k ∈ {ℐ}_{M} , i ∈ [ N ] , j ∈ [ S ] , W ∈ {\{ 0 , 1 \}}^{S}} ) .$$

3. Recall that ∇k∈ [symbol] , [symbol] _{M}_{ₖ}_{,N,S}=[N]33 [S]×{0, 1}^{S}×[Qₖ], and that we denote any element in it as θₖ=(i, j, W, q)∈ [symbol] _{M}_{ₖ}_{,N,S} where the only component in the tuple θₖ depending on k is q∈[Qₖ]. For simplicity of notations, we enumerate the states of each Mₖ as 1, . . . , q, i.e., [Qₖ]=[Q] for some Q∈ [symbol] . Invoke the IPFE decryption to compute all label values as:

$$∀ k ∈ {ℐ}_{M} {: 〚 {ℓ}_{k , init} 〛}_{T} = IPFE . Dec ( IPFE . {SK}_{k , init} , IPFE . {CT}_{k , init} )$$

$$∀ k ∈ {ℐ}_{M} , t ∈ [ T ] , {θ}_{k} = ( i , j , W , q ) ∈ {𝒞}_{{M}_{k} , N , S} {: 〚 {ℓ}_{k , t , {θ}_{k}} 〛}_{T} = IPFE . Dec ( IPFE . {SK}_{k , q} , IPFE . {CT}_{k , t , i , j , W} )$$

$$∀ k ∈ {ℐ}_{M} , {θ}_{k} = ( i , j , W , q ) ∈ {𝒞}_{{M}_{k} , N , S} {: 〚 {ℓ}_{k , T + 1 , {θ}_{k}} 〛}_{T} = IPFE . Dec ( {k , q}_{} , {k , T + 1 , i , j , W}_{} )$$

4. Next, invoke the AKGS evaluation and obtain the combined value

$${〚 μ 〛}_{T} = {\prod }_{k ∈ {ℐ}_{M}} Eval ( ( {M}_{k} , {1}^{N} , {1}^{T} , {1}^{{2}^{S}} , p ) , x , {〚 {ℓ}_{k , init} 〛}_{T} , {\{ {〚 {ℓ}_{k , t , {θ}_{k}} 〛}_{T} \}}_{t ∈ [ T + 1 ] , {θ}_{k} ∈ {𝒞}_{{M}_{k} , N , S}} )$$

5. Finally, it returns μ=D Log_{gT}( [symbol] μ [symbol] _{T}), where g_{T}=e(g₁, g₂). We assume that the desired attribute-weighted sum lies within a specified polynomial-sized domain so that discrete logarithm can be solved via brute-force.

### 4 1-Slot FE for Unbounded AWS for L

We construct a public key 1-slot FE scheme for the unbounded attribute-weighted sum functionality for L. The scheme satisfies the same properties as of the

$$SK - UAW {S}_{( 1 , 1 , 1 )}^{L} .$$

However the public key scheme supports releasing polynomially many secret keys and a single challenge ciphertext, hence we denote the scheme as

$$PK - UAW {S}_{( p o l y , 1 , 1 )}^{L} .$$

Along with the AKGS for Logspace Turing machines we require a function-hiding slotted IPFE=(IPFE.Setup, IPFE.KeyGen, IPFE.Enc, IPFE.SlotEnc, IPFE.Dec) based on G, where G=( [symbol] ₁, [symbol] ₂, [symbol] _{T}, g₁, g₂, e) is pairing group tuple of prime order p.

### 4.1 The Construction

We now describe the

$$PK - {UAWS}_{( poly , 1 , 1 )}^{L} = ( Setup , KeyGen , Enc , Dec ) .$$

Setup (1^{λ}): On input the security parameter, fix a prime integer p∈N and define the slots for generating two pair of IPFE master keys as follows:

$${𝒮}_{pub} = \{ {index}_{1} , {index}_{2} , pad , {init}^{pub} , r a n {d}^{pub} , {acc}^{pub} \} ⋃ \{ {tb}_{τ}^{pub} \vert τ ∈ 𝒯 \} , {𝒮}_{copy} = \{ i n i {t}^{copy} , ran {d}^{copy} \} ⋃ \{ t {b}_{τ}^{copy} \vert τ ∈ 𝒯 \} , {𝒮}_{priv} = {S}_{copy} ⋃ {S}_{1 - UAWS} ⋃ \{ {pad}^{copy} , {pad}^{temp} , {acc}^{perm} , {sim}^{copy} \} , \\ {\tilde{𝒮}}_{pub} = \{ {index}_{1} , {index}_{2} , {rand}^{pub} , {acc}^{pub} \} , {\tilde{𝒮}}_{1 , copy} = \{ r a n {d}_{1}^{copy} , {acc}_{1}^{copy} \} , {\tilde{𝒮}}_{2 , copy} = \{ r a n {d}_{2}^{copy} , {acc}_{2}^{copy} \} , {\tilde{𝒮}}_{priv} = {\tilde{𝒮}}_{1 , copy} ⋃ {\tilde{𝒮}}_{2 , copy} ⋃ {\tilde{𝒮}}_{1 - UAWS} ⋃ \{ {sim}^{copy} \}$$

It generates (IPFE.MPK, IPFE.MSK)←IPFE.Setup(S_{pub}, Sₚᵣᵢᵥ) and (IPFE. [symbol] , IPFE. [symbol] )←IPFE.Setup (\tilde{S}_{pub}, \tilde{S}ₚᵣᵢᵥ) and returns MSK=(IPFE.MSK, IPFE. [symbol] ) and MPK=(IPFE.MPK, IPFE. [symbol] ).
KeyGen (MSK, (M, [symbol] )): On input the master secret key MSK=(IPFE.MSK, IPFE. [symbol] ) and a function tuple M= [symbol] indexed w.r.t. an index set [symbol] of arbitrary size, it parses Mₖ=(Qₖ, yₖ, δₖ)∈TM ∇k∈ [symbol] and samples the set of elements

$$\{ α , {β}_{k} ← {ℤ}_{p} \vert k ∈ {ℐ}_{M} , {\sum }_{k} {β}_{k} = 0 mod p \} .$$

It computes a secret key IPFE.SK_{pad}←IPFE.KeyGen(IPFE.MSK, [symbol] v_{pad} [symbol] ₂) for the following vector v_{pad}:

| vector | index₁ | index₂ | pad | init^{pub} | rand^{pub} | acc^{pub} | ${tb}_{τ}^{pub}$ | in Sₚᵣᵢᵥ |
|---|---|---|---|---|---|---|---|---|
| υ_{pad} | 0 | 0 | α | 0 | 0 | 0 | 0 | 0 |

For all k∈ [symbol] , do the following:
1. For Mₖ=(Qₖ, yₖ, δₖ), compute transition blocks M_{k,τ}∈{0, 1}^{Q}^{ₖ}^{×Q}^{ₖ}, ∇τ531 [symbol] .
2. Sample independent random vector

$${r}_{k , f} ← {ℤ}_{p}^{{Q}_{k}}$$

and a random element πₖ∈ [symbol] ₚ.
3. For the following vector v_{k,init}, compute a secret key IPFE.SK_{k,init}←IPFE.KeyGen(IPFE.MSK, [symbol] v_{k,init} [symbol] ₂):

| vector | index₁ | index₂ | pad | init^{pub} | rand^{pub} | acc^{pub} | ${tb}_{τ}^{pub}$ | in Sₚᵣᵢᵥ |
|---|---|---|---|---|---|---|---|---|
| υ_{k,init} | πₖ | k · πₖ | 0 | r_{k,f}[1] | 0 | βₖ | 0 | 0 |

4. For each q∈[Qₖ], compute the following secret keys

$$IPFE . {SK}_{k , q} ← IPFE . KeyGen ( IPFE . MSK , {〚 {υ}_{k , q} 〛}_{2} \\ and \\ ← IPFE . KeyGen ( IPFE . , {〚 {\tilde{υ}}_{k , q} 〛}_{2} )$$

where the vectors v_{k,q}, \tilde{v}_{k,q} are defined as follows:

| vector | index₁ | index₂ | pad | init^{pub} | rand^{pub} | acc^{pub} | ${tb}_{τ}^{pub}$ | in Sₚᵣᵢᵥ |
|---|---|---|---|---|---|---|---|---|
| υ_{k,q} | πₖ | k · πₖ | 0 | 0 | −r_{k,f}[q] | 0 | (M_{k,τ}r_{k,f} )[q] | 0 |

| vector | index₁ | index₂ | rand^{pub} | acc^{pub} | in \tilde{S}ₚᵣᵢᵥ |
|---|---|---|---|---|---|
| \tilde{υ}_{k,q} | k | k · πₖ | −r_{k,f}[q] | α · yₖ[q] | 0 |

Finally, it returns the secret key as

$${SK}_{( M , {ℐ}_{M} )} = ( ( M , {ℐ}_{M} ) , IPFE . {SK}_{p a d} , {\{ IPFE . {SK}_{k , i n i t} , {\{ IPFE . {SK}_{k , q} , \}}_{q ∈ [ {Q}_{k} ]} \}}_{k ∈ {ℐ}_{M}} ) .$$

Enc (MPK, (x, 1^{T}, 1²^{^{S}}), z): On input the master public key MPK=(IPFE.MPK, IPFE. [symbol] ), a public attribute x∈{0, 1} for some arbitrary N≥1 with time and space complexity bounds given by T, S≥1 (as 1^{T}, 1²^{^{S}}) respectively, and the private attribute

$$𝓏 ∈ {ℤ}_{p}^{n}$$

for some arbitrary n≥1, 10 samples s← [symbol] ₚ and compute a ciphertext IPFE.CT_{pad}←IPFE.Enc(IPFE.MPK, [symbol] u_{pad} [symbol] ₁) for the vector u_{pad}:

| vector | index₁ | index₂ | pad | init^{pub} | rand^{pub} | acc^{pub} | ${tb}_{τ}^{pub}$ | in Sₚᵣᵢᵥ |
|---|---|---|---|---|---|---|---|---|
| u_{pad} | 0 | 0 | s | 0 | 0 | 0 | 0 | 0 |

Next, it does the following:
1. Sample a random vector

$${r}_{x} ← {ℤ}_{p}^{[ 0 , T ] \times [ N ] \times [ S ] \times {\{ 0 , 1 \}}^{s}} .$$

2. For each k∈[n], do the following:
   (a) Sample a random element ρₖ← [symbol] ₚ.
   (b) Compute a ciphertext IPFE.CT_{k,init}←IPFE.SlotEnc(IPFE.MPK, [symbol] u_{k,init} [symbol] ₁) for the vector u_{k,init}:

| vector | index₁ | index₂ | pad | init^{pub} | rand^{pub} | acc^{pub} | ${tb}_{τ}^{pub}$ | in Sₚᵣᵢᵥ |
|---|---|---|---|---|---|---|---|---|
| u_{k,init} | −k · ρₖ | ρₖ | 0 | s · rₓ[(0, 1, 1, 0_{S})] | 0 | s | 0 | ⊥ |

(c) For all t∈[T], i∈[N], j∈[S], W∈{0, 1}^{S}, do the following:
   (i) Compute the transition coefficients c_{τ}(x; t, i, j, W; rₓ), ∇τ∈ [symbol] using rₓ.
   (ii) Compute IPFE.CT_{k,t,i,j}w←IPFE.SlotEnc(IPFE.MPK, [symbol] u_{k,t,i,j}w [symbol] ₁) for the vector u_{k,t,i,j}w:

| vector | index₁ | index₂ | pad | init^{pub} | rand^{pub} | acc^{pub} | ${tb}_{τ}^{pub}$ | in Sₚᵣᵢᵥ |
|---|---|---|---|---|---|---|---|---|
| u_{k,t,i,j,W} | −k · ρₖ | ρₖ | 0 | 0 | s · rₓ[(t − 1, i, j, W )] | 0 | s · c_{τ}(x; t, i, j, W; rₓ) | ⊥ |

(d) For t=T+1, and for all i∈[N], j∈[S], W∈{0, 1}^{S}, compute [symbol] _{k,T+1,i,j}w←IPFE.SlotEnc(IPFE. [symbol] , [symbol] u_{k,T+1,i,j}w [symbol] ₁) for the vector ũ_{k,T+1,i,j}w:

index2

| vector | index₁ | index₂ | rand^{pub} | acc^{pub} | in \tilde{S}ₚᵣᵢᵥ |
|---|---|---|---|---|---|
| ũ_{k, T + 1, i, j, W} | −k · ρₖ | ρₖ | s · rₓ[(T, i, j, W)] | s · z[k] | ⊥ |

3. Finally, it returns the ciphertext as

$$C {T}_{( x , T , S )} = ( ( x , T , S ) , n , IPFE . {CT}_{p a d} , {\{ IPFE . C {T}_{k , i n i t} , {\{ IPFE . {CT}_{k , t , i , j , W} \}}_{t ∈ [ T ]} , {k , T + 1 , i , j , W}_{} \}}_{k ∈ [ n ] , i ∈ [ N ] , j ∈ [ S ] , W ∈ {\{ 0 , 1 \}}^{s}} ) .$$

Dec (SK_{(M,I}_{_{M}}₎, CT_{(x,T,S)}): On input a secret key [symbol] and a ciphertext CT_{(x,T,S)}, do the following:
   1. Parse [symbol] and CT_{(x,T,S)} as follows:

$${SK}_{( M , {ℐ}_{M} )} = ( ( {( {M}_{k} )}_{k ∈ {ℐ}_{M}} , {ℐ}_{M} ) , IPFE . {SK}_{p a d} , {\{ IPFE . {SK}_{k , i n i t} , {\{ IPFE . S {K}_{k , q} , {k , q}_{} \}}_{q ∈ [ {Q}_{k} ]} \}}_{k ∈ {ℐ}_{M}} ) , {M}_{k} = ( {Q}_{k} , {y}_{k} , {δ}_{k} ) ,$$

$${CT}_{( x , T , S )} = ( ( x , T , S ) , n , IPFE . {CT}_{p a d} , {\{ IPFE . {CT}_{k , i n i t} , {\{ IPFE . {CT}_{k , t , i , j , W} \}}_{t ∈ [ T ]} , {k , T + 1 , i , j , W}_{} \}}_{k ∈ [ n ] , i ∈ [ N ] , j ∈ [ S ] , W ∈ {\{ 0 , 1 \}}^{s}} ) .$$

2. Output ⊥, if [symbol] ⊥[n]. Else, select the sequence of ciphertexts for the indices k∈ [symbol] as

$${CT}_{( x , T , S )} = ( ( x , T , S ) , {\{ IPFE . {CT}_{k , i n i t} , {\{ IPFE . {CT}_{k , t , i , j , W} \}}_{t ∈ [ T ]} , {}_{k , T + 1 , i , j , W} \}}_{k ∈ {ℐ}_{M} , i ∈ [ N ] , j ∈ [ S ] , W ∈ {\{ 0 , 1 \}}^{s}} ) .$$

3. Use the IPFE decryption to obtain [symbol] μ_{pad} [symbol] ←IPFE.Dec(IPFE.SK_{pad}, IPFE.CT_{pad}).
4. Recall that ∇k∈ [symbol] , C_{M}_{ₖ}_{,N,S}=[N]×[S]×{0, 1}^{S}×[Qₖ], and that we denote any element in it as θₖ=(i, j, W, q)∈ [symbol] _{M}_{ₖ}_{,N,S} where the only component in the tuple θₖ depending on k is q∈[Qₖ]. Invoke the IPFE decryption to compute all label values as:

$$∀ k ∈ {ℐ}_{M} {: 〚 {ℓ}_{k , init} 〛}_{T} = IPFE . Dec ( IPFE . {SK}_{k , i n i t} , IPFE . {CT}_{k , i n i t} ) \\ ∀ k ∈ {ℐ}_{M} , t ∈ [ T ] , {θ}_{k} = ( i , j , W , q ) ∈ {𝒞}_{{M}_{k} , N , S} : {〚 {ℓ}_{k , t , {θ}_{k}} 〛}_{T} = IPFE . Dec ( IPFE . S {K}_{k , q} , IPFE . {CT}_{k , t , i , j , W} ) \\ ∀ k ∈ {ℐ}_{M} , {θ}_{k} = ( i , j , W , q ) ∈ {𝒞}_{{M}_{k} , N , S} : {〚 {ℓ}_{k , T + 1 , {θ}_{k}} 〛}_{T} = IPFE . Dec ( {k , q}_{} , {k , T + 1 , i , j , W}_{} )$$

5. Next, invoke the AKGS evaluation procedure and obtain the combined value

$${〚 μ 〛}_{T} = {\prod }_{k ∈ {ℐ}_{M}} Eval ( ( {M}_{k} , {1}^{N} , {1}^{T} , {1}^{{2}^{S}} , p ) , x , {〚 {ℓ}_{k , init} 〛}_{T} , {\{ {〚 {ℓ}_{k , t , {θ}_{k}} 〛}_{T} \}}_{t ∈ [ T + 1 ] , {θ}_{k} ∈ {𝒞}_{{M}_{k} , N , S}}$$

6. Finally, it returns μ′ such that [symbol] μ [symbol] _{T}=( [symbol] μ_{pad} [symbol] _{T})^{μ′}, where g_{T}=e(g₁, g₂). We assume that the desired attribute-weighted sum lies within a specified polynomial-sized domain so that μ′ can be searched via brute-force.

### 5 System Implementations

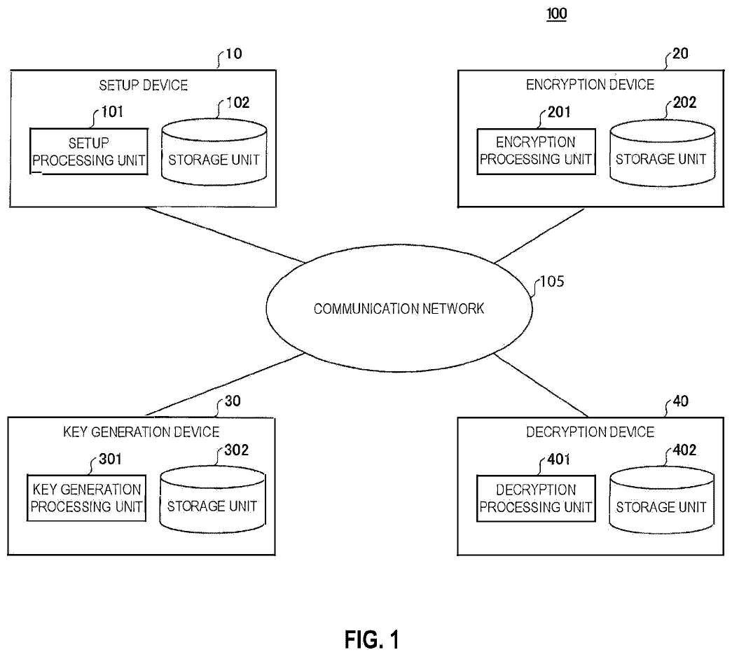

FIG. 1 illustrates an encryption system 100 in an embodiment of the present invention including a setup algorithm Setup, an encryption algorithm Enc, a key generation algorithm KeyGen, and a decryption algorithm Dec of the functional encryption implementations. As illustrated in FIG. 1, the encryption system 100 in the embodiment of the present invention includes a setup device 10, an encryption device 20, a key generation device 30, and a decryption device 40. These devices are communicably connected to each other via a communication network 105.

The setup device 10 can be a computer or a computer system configured to execute the setup algorithm Setup. The setup device 10 includes a setup processing unit 101 and a storage unit 102. The setup processing unit 101 executes the setup algorithm Setup as described herein. In the setup algorithm Setup, a functional encryption setup algorithm executes twice to generate and output a set of master public-secret key pairs FE.MSK and FE.MPK and a set of master public-secret key pairs [symbol] and [symbol] . The first FE key pair (FE.MPK, FE.MSK) can be used for encrypting a public part of attributes and the second FE key pair ( [symbol] , [symbol] ) can be used for use in encrypting a private part of the attributes. In the storage unit 102, various types of information used in the setup algorithm Setup, an output result of the setup algorithm Setup, and the like are stored.

Note that the setup processing unit 101 can be implemented by the processing of executing, by an arithmetic device such as a processor, one or more programs installed in the setup device 10, for example. The storage unit 102 can be implemented using various memories (e.g., a main storage device and an auxiliary storage device).

The encryption device 20 can be a computer or a computer system configured to execute the encryption algorithm Enc. The encryption device 20 includes an encryption processing unit 201 and a storage unit 202. The encryption processing unit 201 executes the encryption algorithm by receiving the master public key MPK as FE.MPK and [symbol] , one or more public attributes x, and one or more private attributes z={zₜ}_{t∈I}_{_{z}}, and computing FE ciphertext FE.CT_{t,init} for the value u_{t,init}. The storage unit 202 stores various types of information used in the encryption algorithm Enc, an output result (e.g., the ciphertext) of the encryption algorithm Enc, and the like are stored.

Note that the encryption processing unit 201 can be implemented by the processing of executing, by an arithmetic device such as a processor, one or more programs installed in the encryption device 20, for example. The storage unit 202 can be implemented using various memories (e.g., a main storage device and an auxiliary storage device).

The key generation device 30 is a computer or a computer system configured to execute the key generation algorithm KeyGen. The key generation device 30 can include a key generation processing unit 301 and a storage unit 302. The key generation processing unit 301 executes the key generation algorithm KeyGen by receiving the master secret key MSK as FE.MSK and [symbol] from the setup storage unit and a function M= [symbol] and outputting the secret key SK_{M} as FE.SK_{pad}, {FE.SK_{t,init}, FE.SKₜ}, { [symbol] } and M, and storing the output in an electronic key generation storage unit. In the storage unit 302, various types of information used in the key generation algorithm KeyGen, an output result of the key generation algorithm KeyGen, and the like are stored.

Note that the key generation processing unit 301 is implemented by the processing of executing, by an arithmetic device such as a processor, one or more programs installed in the key generation device 30, for example. The storage unit 302 can be implemented using various memories (e.g., a main storage device and an auxiliary storage device).

The decryption device 40 can be a computer or a computer system configured to execute the decryption algorithm Dec. The decryption device 40 includes a decryption processing unit 401 and a storage unit 402. The decryption processing unit 401 executes the decryption algorithm by receiving the function M and the secret key SK_{M} for function M; receiving one or more public attributes x and a ciphertext CT for x and recovering the functional value μ from ρ_{pad} and d, and outputting the value μ as the plaintext and storing the output in an electronic decryption device storage unit. In the storage unit 402, various types of information used in the decryption algorithm Dec, an output result of the decryption algorithm Dec, and the like are stored.

Note that the decryption processing unit 401 is implemented by the processing of executing, by an arithmetic device such as a processor, one or more programs installed in the decryption device 40, for example. The storage unit 402 can be implemented using various memories (e.g., a main storage device and an auxiliary storage device).

The configuration of the encryption system 100 illustrated in FIG. 1 is an example, and other configurations may be employed. For example, any two or more devices of the setup device 10, the encryption device 20, and the key generation device 30 maybe configured as a single device. The encryption system 100 may include a plurality of decryption devices 40. Similarly, any one or more devices of the setup device 10, the encryption device 20, and the key generation device 30 may be provided as a plurality of devices.

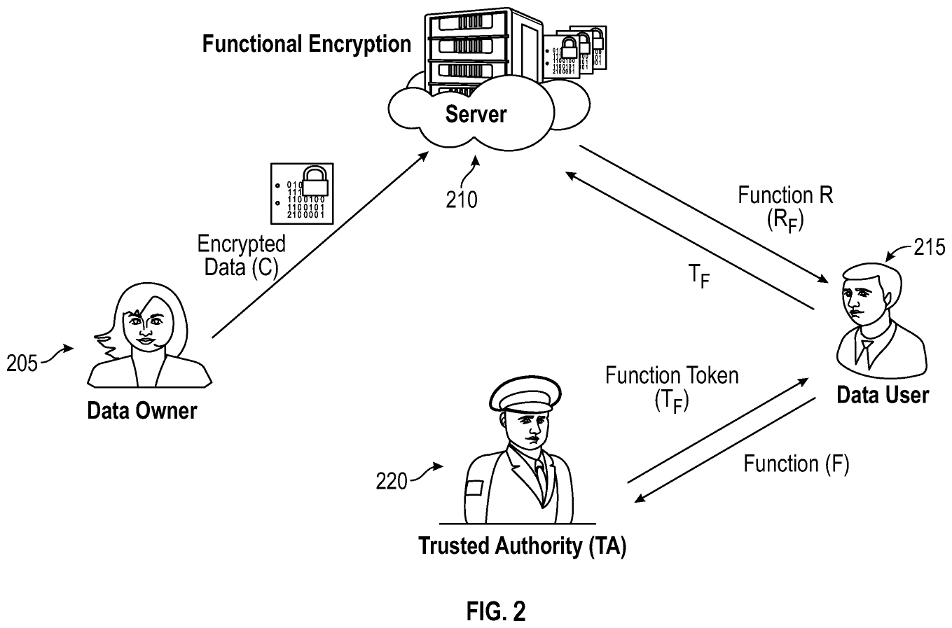

With reference to FIG. 2, an example system architecture is illustrated. A user 215 allows a remote server 210 to run a specific function F on a ciphertext by issuing a token T_{F}. The server executes F on an available ciphertext C and generates a result R_{F} an encrypted form. The system can include a trusted authority (TA) 220 who is responsible to construct a token T_{F} for the requested function.

As illustrated, data owner 205 uploads ciphertext C onto the remote server 210. Data user 215 requests TA 220 for a token for a function F. TA 220 issues token T_{F} to the data user. Data user then sends T_{F} to the server. Server runs F on the encrypted data, and forwards the result R_{F} to the data user.

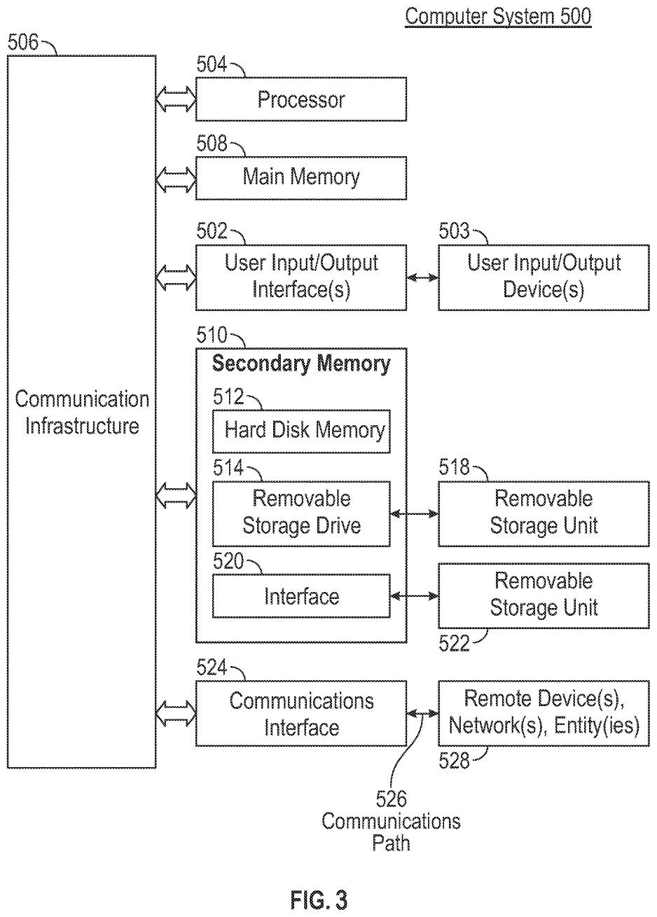

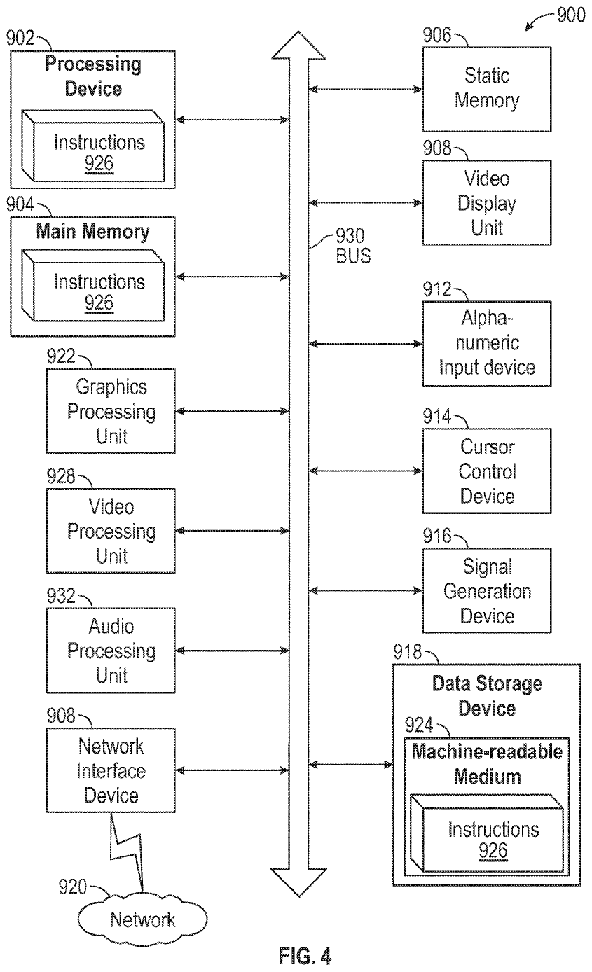

FIGS. 3 and 4 depict example computer systems useful for implementing various embodiments described in the present disclosure. Various embodiments may be implemented, for example, using one or more computer systems, such as computer system 500 shown in FIG. 3. One or more computer system(s) 500 may be used, for example, to implement any of the embodiments discussed herein, as well as combinations and sub-combinations thereof.

Computer system 500 may include one or more processors (also called central processing units, processing devices, or CPUs), such as a processor 504. Processor 504 may be connected to a communication infrastructure 506 (e.g., such as a bus).

Computer system 500 may also include user input/output device(s) 503, such as monitors, keyboards, pointing devices, etc., which may communicate with communication infrastructure 506 through user input/output interface(s) 502. One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main memory 508, such as random-access memory (RAM). Main memory 508 may include one or more levels of cache. Main memory 508 may have stored therein control logic (i.e., computer software, instructions, etc.) and/or data. Computer system 500 may also include one or more secondary storage devices or secondary memory 510. Secondary memory 510 may include, for example, a hard disk drive 512 and/or a removable storage device or removable storage drive 514. Removable storage drive 514 may interact with a removable storage unit 518. Removable storage unit 518 may include a computer-usable or readable storage device having stored thereon computer software (control logic) and/or data. Removable storage drive 514 may read from and/or write to removable storage unit 518.

Secondary memory 510 may include other means, devices, components, instrumentalities, or other approaches for allowing computer programs and/or other instructions and/or data to be accessed by computer system 500. Such means, devices, components, instrumentalities, or other approaches may include, for example, a removable storage unit 522 and an interface 520. Examples of the removable storage unit 522 and the interface 520 may include a program cartridge and cartridge interface, a removable memory chip (such as an EPROM or PROM) and associated socket, a memory stick and USB port, a memory card and associated memory card slot, and/or any other removable storage unit and associated interface.

Computer system 500 may further include communications interface 524 (e.g., network interface). Communications interface 524 may enable computer system 500 to communicate and interact with any combination of external devices, external networks, external entities, etc. (individually and collectively referenced as remote device(s), network(s), entity(ies) 528).

For example, communications interface 524 may allow computer system 500 to communicate with external or remote device(s), network(s), entity(ies) 528 over communications path 526, which may be wired and/or wireless (or a combination thereof), and which may include any combination of LAN, WANs, the Internet, etc. Control logic and/or data may be transmitted to and from computer system 500 via communications path 526.

Computer system 500 may also be any of a personal digital assistant (PDA), desktop workstation, laptop or notebook computer, netbook, tablet, smartphone, smartwatch or other wearable devices, appliance, part of the Internet-of-Things, and/or embedded system, to name a few non-limiting examples, or any combination thereof.

Computer system 500 may be a client or server computing device, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (Saas), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

FIG. 4 illustrates an example machine of a computer system 900 within which a set of instructions, for causing the machine to perform any one or more of the operations discussed herein, may be executed. In alternative implementations, the machine may be connected (e.g., networked) to other machines in a LAN, an intranet, an extranet, and/or the Internet. The machine may operate in the capacity of a server or a client machine in a client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, a specialized application or network security appliance or device, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 900 includes a processing device 902, a main memory 904 (e.g., read-only memory (ROM), flash memory, dynamic random-access memory (DRAM) such as synchronous DRAM (SDRAM), etc.), a static memory 906 (e.g., flash memory, static random-access memory (SRAM), etc.), and a data storage device 918, which communicate with each other via a bus 930.

Processing device 902 represents one or more processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 902 may also be one or more special-purpose processing devices such as an application-specific integrated circuit (ASIC), a field-programmable gate array (FPGA), a digital signal processor (DSP), network processor, or the like. The processing device 902 is configured to execute instructions 926 for performing the operations and steps discussed herein.

The computer system 900 may further include a network interface device 908 to communicate over the network 920. The computer system 900 also may include a video display unit 910, an alphanumeric input device 912 (e.g., a keyboard), a cursor control device 914 (e.g., a mouse), a graphics processing unit 922, a signal generation device 916 (e.g., a speaker), graphics processing unit 922, video processing unit 928, and audio processing unit 932.

The data storage device 918 may include a machine-readable medium 924 (also known as a computer-readable storage medium) on which is stored one or more sets of instructions 926 (e.g., software instructions) embodying any one or more of the operations described herein. The instructions 926 may also reside, completely or at least partially, within the main memory 904 and/or within the processing device 902 during execution thereof by the computer system 900, where the main memory 904 and the processing device 902 also constitute machine-readable storage media.

In an example, the instructions 926 include instructions to implement operations and functionality corresponding to the disclosed subject matter. While the machine-readable storage medium 924 is shown in an example implementation to be a single medium, the term “machine-readable storage medium” should be taken to include a single medium or multiple media (e.g., a centralized or distributed database, and/or associated caches and servers) that store the one or more sets of instructions 926. The term “machine-readable storage medium” shall also be taken to include any medium that is capable of storing or encoding a set of instructions 926 for execution by the machine and that cause the machine to perform any one or more of the operations of the present disclosure. The term “machine-readable storage medium” shall accordingly be taken to include, but not be limited to, solid-state memories, optical media, and magnetic media.

Some portions of the detailed description have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a computer selectively activated or reconfigured by a computer program stored in the computer. Such a computer program may be stored in a computer-readable storage medium, such as but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The operations and illustrations presented herein are not inherently related to any particular computer or other apparatus. Various types of systems may be used with programs in accordance with the teachings herein, or it may prove convenient to construct a more specialized apparatus to perform the operations. The structure for a variety of these systems will appear as set forth in the description herein. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as read-only memory (“ROM”), random access memory (“RAM”), magnetic disk storage media, optical storage media, flash memory devices, etc.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems, and/or computer architectures other than that shown in FIGS. 3 and 4. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible and are within the scope and spirit of this disclosure. For example, and without limiting the generality of this paragraph, embodiments are not limited to the software, hardware, firmware, and/or entities illustrated in the figures described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments but should be defined only in accordance with the following claims and their equivalents. In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

1. A computerized method for encrypting for a functional encryption scheme in a public key setting supporting multiple secret keys and multiple ciphertexts, the method comprising:
executing a computerized setup algorithm, the setup algorithm comprising:
receiving a security parameter;
executing a functional encryption setup algorithm twice to generate a set of master public-secret key pairs FE.MSK and FE.MPK and a set of master public-secret key pairs [symbol] and [symbol] ;
outputting a master secret key MSK as FE.MSK and [symbol] and a master public key MPK as FE.MPK and [symbol] , and storing the output master keys in an electronic setup storage unit, wherein the master keys MSK and MPK only depend on the security parameter;
executing a computerized key generation algorithm by:
receiving the master secret key MSK as FE.MSK and [symbol] from the setup storage unit and a function M= [symbol] where Mₜ are sub-functions, wherein t represents an integer index and Mₜ accepts an arbitrary length of inputs and Mₜ is computed by multiplying several matrices M_{t,τ}, wherein τ represents an integer index and wherein [symbol] represents a set of indices being natural numbers;
sampling random values α, βₜ such that a sum of all entries of βₜ is 0;
setting value v_{pad} comprising a and padded with zeroes and generating an FE secret key FE.SK_{pad} for the values v_{pad};
sampling random values rₜ for setting values v_{t,init} comprising rₜ and βₜ, padded with zeroes and appended with a randomized encoding of the index t and generating an FE secret key FE.SK_{t,init} for the values v_{t,init};
setting values vₜ comprising rₜ, M_{t,τ}, padded with zeroes and appended with a randomized encoding of the index t and generating an FE secret key FE.SKₜ for the values vₜ;
setting values \tilde{v}ₜ comprising rₜ, α, padded with zeroes and appended with a randomized encoding of the index t and generating an FE secret key [symbol] ₜ for the values \tilde{v}ₜ; and
outputting the secret key SK_{M} as FE.SK_{pad}, {FE.SK_{t,init}, FE.SKₜ}, { [symbol] } and M, and storing the output in an electronic key generation storage unit.

2. The method of claim 1, further comprising an encryption method, the encryption method comprising:
receiving the master public key MPK as FE.MPK and [symbol] , one or more public attributes x, and one or more private attributes z={zₜ}_{t∈I}_{_{z}}, wherein t represents an integer index;
sampling randomness s and setting values u_{pad} comprising s, padding with zeroes, and computing FE ciphertext FE.CT_{pad} for the value u_{pad};
sampling random values rₓ for setting values u_{t,init} comprising rₓ, s, padded with zeroes and appended with a randomized encoding of the index t, and computing FE ciphertext FE.CT_{t,init} for the value u_{t,init};
computing coefficients cₜ comprising x, rₓ and setting values uₜ comprising rₓ, S, cₜ, padded with zeroes and appended with a randomized encoding of the index t, and computing FE ciphertext FE.CTₜ for the value uₜ;
setting values uₜ comprising rₓ, s, zₜ, padded with zeroes and appended with a randomized encoding of the index t, and computing FE ciphertext [symbol] for the value ũₜ; and
outputting the ciphertext CT as FE.CT_{pad} and {FE.CT_{t,init}, FE.CTₜ}, { [symbol] } and storing the output in an electronic encryption device storage unit.

3. The method of claim 2, further comprising a decryption method, the decryption method comprising:
receiving the function M and the secret key SK_{M} for function M;
receiving one or more public attributes x and a ciphertext CT for x;
retrieving FE.SK_{pad}, {FE.SK_{t,init}, FE.SKₜ}, { [symbol] } from SK_{M} and retrieving FE.CT_{pad} and {FE.CT_{t,init}, FE.CTₜ}, { [symbol] } from CT;
retrieving sub-functions Mₜ from the function M;
upon verifying [symbol] proceeds as follows:
decrypting FE.CT_{pad} by running the decryption algorithm of FE using the secret key FE.SK_{pad} and get a value ρ_{pad};
decrypting FE.CT_{t,init} by running the decryption algorithm of FE using the secret key FE.SK_{t,init} and get a value [symbol] ;
decrypting FE.CTₜ by running the decryption algorithm of FE using the secret key FE.SKₜ and get a value [symbol] ₜ;
decrypting [symbol] by running the decryption algorithm of FE using the secret key [symbol] and get a value [symbol] ;
running an evaluation algorithm of a garbling procedure using the values [symbol] _{t,init}, [symbol] ₜ, [symbol] and the one or more public attributes x and the sub-function Mₜ, and get a value d; and
recovering the functional value μ from ρ_{pad} and d, and outputting the value μ as the plaintext and storing the output in an electronic decryption device storage unit.

4. The method of claim 1, wherein a first FE key pair (FE.MPK, FE.MSK) is for encrypting a public part of attributes and the second FE key pair ( [symbol] , [symbol] ) is for use in encrypting a private part of the attributes.

5. A system for encrypting for a functional encryption scheme, comprising a processor, wherein the processor is configured for:
executing a computerized setup algorithm, the setup algorithm comprising:
receiving a security parameter;
executing a functional encryption setup algorithm twice to generate a set of master public-secret key pairs FE.MSK and FE.MPK and a set of master public-secret key pairs [symbol] and [symbol] ;
outputting a master secret key MSK as FE.MSK and [symbol] and a master public key MPK as FE.MPK and [symbol] , and storing the output master keys in an electronic setup storage unit, wherein the master keys MSK and MPK only depend on the security parameter;
executing a computerized key generation algorithm by:
receiving the master secret key MSK as FE.MSK and [symbol] from the setup storage unit and a function M= [symbol] where Mₜ are sub-functions, wherein t represents an integer index and Mₜ accepts arbitrary length of inputs and Mₜ is computed by multiplying several matrices M_{t,τ}, wherein τ represents an integer index and wherein [symbol] represents a set of indices being natural numbers;
sampling random values α, βₜ such that the sum of all entries of βₜ is 0;
setting value v_{pad} comprising a and padded with zeroes and generating an FE secret key FE.SK_{pad} for the values v_{pad};
sampling random values rₜ for setting values v_{t,init} comprising rₜ and βₜ, padded with zeroes and appended with a randomized encoding of the index t and generating an FE secret key FE.SK_{t,init} for the values v_{t,init};
setting values vₜ comprising rₜ, M_{t,τ}, padded with zeroes and appended with a randomized encoding of the index t and generating an FE secret key FE.SKₜ for the values vₜ;
setting values \tilde{v}ₜ comprising rₜ, α, padded with zeroes and appended with a randomized encoding of the index t and generating an FE secret key [symbol] for the values \tilde{v}ₜ; and
outputting the secret key SK_{M} as FE.SK_{pad}, {FE.SK_{t,init}, FE.SKₜ}, { [symbol] } and M, and storing the output in an electronic key generation storage unit.

6. The system of claim 5, wherein the processor is further configured for:
receiving the master public key MPK as FE.MPK and [symbol] , one or more public attributes x, and one or more private attributes z= [symbol] wherein t represents an integer index;
sampling randomness s and setting values u_{pad} comprising s, padding with zeroes, and computing FE ciphertext FE.CT_{pad} for the value u_{pad};
sampling random values rₓ for setting values u_{t,init} comprising rₓ, s, padded with zeroes and appended with a randomized encoding of the index t, and computing FE ciphertext FE.CT_{t,init} for the value u_{t,init};
computing coefficients cₜ comprising x, rₓ and setting values uₜ comprising rₓ, S, cₜ, padded with zeroes and appended with a randomized encoding of the index t, and computing FE ciphertext FE.CTₜ for the value uₜ;
setting values ũₜ comprising rₓ, s, zₜ, padded with zeroes and appended with a randomized encoding of the index t, and computing FE ciphertext [symbol] for the value ũₜ; and
outputting the ciphertext CT as FE.CT_{pad} and {FE.CT_{t,init}, FE.CTₜ}, { [symbol] } and storing the output in an electronic encryption device storage unit.

7. The system of claim 6, wherein the processor is further configured for:
receiving the function M and the secret key SK_{M} for function M;
receiving one or more public attributes x and a ciphertext CT for x;
retrieving FE.SK_{pad}, {FE.SK_{t,init}, FE.SKₜ}, { [symbol] } from SK_{M} and retrieving FE.CT_{pad} and {FE.CT_{t,init}, FE.CTₜ}, { [symbol] } from CT;
retrieving sub-functions Mₜ from the function M;
upon verifying [symbol] proceeds as follows:
decrypting FE.CT_{pad} by running the decryption algorithm of FE using the secret key FE.SK_{pad} and get a value ρ_{pad};
decrypting FE.CT_{t,init} by running the decryption algorithm of FE using the secret key FE.SK_{t,init} and get a value [symbol] _{t,init};
decrypting FE.CTₜ by running the decryption algorithm of FE using the secret key FE.SKₜ and get a value [symbol] ₜ;
decrypting [symbol] by running the decryption algorithm of FE using the secret key [symbol] and get a value [symbol] ₜ;
running an evaluation algorithm of a garbling procedure using the values [symbol] _{t,init}, [symbol] ₜ, [symbol] and the one or more public attributes x and the sub-function Mₜ, and get a value d; and
recovering the functional value μ from ρ_{pad} and d, and outputting the value μ as the plaintext and storing the output in an electronic decryption device storage unit.

8. The system of claim 5, wherein a first FE key pair (FE.MPK, FE.MSK) is for encrypting a public part of attributes and the second FE key pair ( [symbol] , [symbol] ) is for use in encrypting a private part of the attributes.

9. One or more tangible, non-transitory, machine-readable media comprising instructions configured to cause a processor to encrypt for a functional encryption scheme, wherein processing the functional encryption scheme comprises:
executing a computerized setup algorithm, the setup algorithm comprising:
receiving a security parameter;
executing a functional encryption setup algorithm twice to generate a set of master public-secret key pairs FE.MSK and FE.MPK and a set of master public-secret key pairs [symbol] and [symbol] ;
outputting a master secret key MSK as FE.MSK and [symbol] and a master public key MPK as FE.MPK and [symbol] , and storing the output master keys in an electronic setup storage unit, wherein the master keys MSK and MPK only depend on the security parameter;
executing a computerized key generation algorithm by:
receiving the master secret key MSK as FE.MSK and [symbol] from the setup storage unit and a function M= [symbol] where Mₜ are sub-functions, wherein t represents an integer index and Mₜ accepts arbitrary length of inputs and Mₜ is computed by multiplying several matrices M_{t,τ}, wherein τ represents an integer index and wherein [symbol] represents a set of indices being natural numbers;
sampling random values α, βₜ such that the sum of all entries of βₜ is 0;
setting value v_{pad} comprising α and padded with zeroes and generating an FE secret key FE.SK_{pad} for the values v_{pad};
sampling random values rₜ for setting values v_{t,init} comprising rₜ and βₜ, padded with zeroes and appended with a randomized encoding of the index t and generating an FE secret key FE.SK_{t,init} for the values v_{t,init};
setting values vₜ comprising rₜ, M_{t,τ}, padded with zeroes and appended with a randomized encoding of the index t and generating an FE secret key FE.SKₜ for the values vₜ;
setting values \tilde{v}ₜ comprising rₜ, α, padded with zeroes and appended with a randomized encoding of the index t and generating an FE secret key [symbol] for the values \tilde{v}ₜ; and
outputting the secret key SK_{M} as FE.SK_{pad}, {FE.SK_{t,init}, FE.SKₜ}, { [symbol] } and M, and storing the output in an electronic key generation storage unit.

10. The one or more machine-readable media of claim 9, wherein processing the encryption method further comprises:
receiving the master public key MPK as FE.MPK and [symbol] , one or more public attributes x, and one or more private attributes z= [symbol] wherein t represents an integer index;
sampling randomness s and setting values u_{pad} comprising s, padding with zeroes, and computing FE ciphertext FE.CT_{pad} for the value u_{pad};
sampling random values rₓ for setting values u_{t,init} comprising rₓ, s, padded with zeroes and appended with a randomized encoding of the index t, and computing FE ciphertext FE.CT_{t,init} for the value u_{t,init};
computing coefficients cₜ comprising x, rₓ and setting values uₜ comprising rₓ, S, cₜ, padded with zeroes and appended with a randomized encoding of the index t, and computing FE ciphertext FE.CTₜ for the value uₜ;
setting values ũₜ comprising rₓ, s, zₜ, padded with zeroes and appended with a randomized encoding of the index t, and computing FE ciphertext [symbol] for the value ũₜ; and
outputting the ciphertext CT as FE.CT_{pad} and {FE.CT_{t,init}, FE.CTₜ}, { [symbol] } and storing the output in an electronic encryption device storage unit.

11. The one or more machine-readable media of claim 10, wherein processing the encryption method further comprises:
receiving the function M and the secret key SK_{M} for function M;
receiving one or more public attributes x and a ciphertext CT for x;
retrieving FE.SK_{pad}, {FE.SK_{t,init}, FE.SKₜ}, { [symbol] } from SK_{M} and retrieving FE.CT_{pad} and {FE.CT_{t,init}, FE.CTₜ}, { [symbol] } from CT;
retrieving sub-functions Mₜ from the function M;
upon verifying [symbol] proceeds as follows:
decrypting FE.CT_{pad} by running the decryption algorithm of FE using the secret key FE.SK_{pad} and get a value ρ_{pad};
decrypting FE.CT_{t,init} by running the decryption algorithm of FE using the secret key FE.SK_{t,init} and get a value [symbol] _{t,init};
decrypting FE.CTₜ by running the decryption algorithm of FE using the secret key FE.SKₜ and get a value [symbol] ₜ;
decrypting [symbol] by running the decryption algorithm of FE using the secret key [symbol] and get a value [symbol] ;
running an evaluation algorithm of the garbling procedure using the values [symbol] _{t,init}, [symbol] ₜ, [symbol] and the one or more public attributes x and the sub-function Mₜ, and get a value d; and
recovering the functional value μ from ρ_{pad} and d, and outputting the value μ as the plaintext and storing the output in an electronic decryption device storage unit.

12. The one or more machine-readable media of claim 9, wherein a first FE key pair (FE.MPK, FE.MSK) is for encrypting a public part of attributes and the second FE key pair ( [symbol] , [symbol] ) is for use in encrypting a private part of the attributes.
